(19) United States
(12) Patent Application Publication
(10) Pub. No.: US 2024/0378508 A1
(43) Pub. Date: Nov. 14, 2024

(54) SYSTEM AND METHOD FOR DETECTING ETHICAL BIAS IN MACHINE LEARNING MODELS

(71) Applicant: HSBC Group Management Services Limited, London (GB)

(72) Inventors: Nilanjan Mukhopadhyay, Kolkata (IN); Avijit Ghosh, Kolkata (IN); James Gorstige, Sheffield (GB)

(21) Appl. No.: 18/745,788

(22) Filed: Jun. 17, 2024

Related U.S. Application Data
(60) Provisional application No. 63/508,739, filed on Jun. 16, 2023.

(51) Int. Cl. G06N 20/00

(52) U.S. Cl. CPC G06N 20/00

(57) ABSTRACT

A computing system is proposed that is configured to automatically interact with and analyze a plurality of target trained machine learning/artificial intelligence models for automated bias detection by automatically generating multiple test data sets for processing through the target trained machine learning models for analysis. The multiple test data sets can include different combinations of bias and control variables, and the outputs can then compared against one another by testing a comparative fit using linear model to the first data set and the second data set to generate a computer-based estimate of whether an ethical bias is present. In further embodiments, the computing system may control a model supervisor process to conduct further re-training and re-testing iterations in an automated attempt to reduce the estimated ethical bias.

### CROSS-REFERENCE

This application is a non-provisional of, and claims all benefit, including priority to, U.S. Provisional Application No. 63/508,739, entitled “System and Method for Detecting Ethical Bias in Machine Learning Models”, dated Jun. 16, 2023, incorporated by reference in its entirety.

### FIELD OF THE DISCLOSURE

The present disclosure relates to machine learning, and more particularly to a computer system and computer implemented method for detecting (estimating) ethical bias in machine learning and artificial intelligence computing models.

### BACKGROUND

Machine learning and artificial intelligence computer implemented techniques are increasingly being used by organizations and entities to make decisions that can impact the lives of target users. For example, machine learning and artificial intelligence are computing approaches that have been used to automate decisions ranging from whether a person should be hired for a given role or whether a person's credit card application should be approved to whether a patient's growth is malignant or benign. To train machine learning and artificial intelligence models, developers may use large data sets of sensitive information such as, but not limited to, education level, salary, income, wealth, biometric data, and the like. However, the training of such machine learning and artificial intelligence models is only as good as the data upon which it is trained. In some circumstances, a developer's or data scientist's bias may extend into the machine learning and artificial intelligence model's training based on how the developer or data scientist compiled the training data set and implemented the training process. In other circumstances, despite the developer's or data scientist's best efforts, bias, in some form, may sneak into the assumptions made by the intelligent system. While some biases are perfectly acceptable, other biases, such as those based on certain protected grounds, such as sex, gender, race, nationality, and ethnicity can be problematic. However, due to limited computing resources, available processing time, and the complexity of modern trained computing models (statistical or machine learning models), it is a major technical challenge to be vigilant in tracking these biases.

### SUMMARY

An improved computer system and corresponding computing approaches, and computer program products/non-transitory computer readable media are proposed herein. In particular, a computer system is proposed that receives as an input, one or more target trained machine learning models, generates input data sets corresponding to control and bias variables, and processes the one or more target trained machine learning models using a selected combination of the control and bias variables to generate two separate output data sets. The two separate output data sets are then processed for comparison through fitting algorithms and approaches using linear models to generate one or more computer outputs indicative of a potential bias based on the selected combination of the control and bias variables. The models can be machine learning models, statistical models, or other forms of artificial intelligence based models.

Additional optional variants are also proposed herein to provide specific technical implementation approaches that are adapted to improve the overall functioning of a practical computing system, including adapting the model testing approaches, flagging, and observation approaches to adapt for limited computing resources and processing time availability.

This output indicative of a potential bias can be a computer generated output that can be used to generate one or more visualizations (e.g., render, on a graphical user interface, one or more graphical interface control elements corresponding to a bias level or materiality thereof of a potential model), or in a set of variant embodiments, control a machine learning model supervisor process to conduct automated downstream control steps relating to the models, such as automatically reverting a trained model to an earlier trained snapshot version, forcing a partial or full re-training of a model using a same or a different set of training features, conducting additional training of a model, or, in a worst case scenario, removing a model from usage entirely by making it unavailable, or deactivating the model.

In this disclosure, a technical computing system and corresponding architecture and framework are proposed for usage with assessing computer representations of models to computationally generate data values that are a computer estimation of bias, using various algorithmic approaches described herein. It is important to note that the computer estimation of bias is based on a specific computing processing approach by running the models with specific parameter sets and computationally analyzing the outputs to automatically generate the computer estimation, and that the estimation is a proxy value for an attempted identification of bias by a computer with limited or not input from a human. Simply because the computer outputs a value indicative of a potential bias does not mean that an actual bias is present, the approaches proposed herein are simply a computational tool that is able to provide a first approximation that can lead to an automatic downstream pre-emptive step taken by a supervisor computing process to de-activate or decommission a model for investigation and/or remediation.

Specifically, the outcome monitoring framework can also be utilized, in a further embodiment, a generated visualization of data for a selected portfolio or set of models, providing a rendered graphical user interface having interactive control elements where a human analyst can be provided with a graphical dashboard showing visual control elements that are rendered based at least on the outputs of the outcome monitoring computing architecture based on automated determinations from the statistical testing framework indicative of additional levels of information presented visually, such as the materiality of the potential bias. In a specific use case, the analyst can use the dashboard to automatically initiate remedial actions, ignore/explain certain biases (for example, if they are spurious, or simply out of the control of the institution). Remedial actions can be taken by the machine learning model supervisor process automatically.

In a more specific embodiment, the machine learning model supervisor process can also be configured to partially re-train a model using an additional feature set selected from a set of features that are identified as potential control variables, re-test the re-trained model, and if the re-trained model is able to maintain a level of model fairness in respect of the re-test, deploy the re-trained model to operate in place of the original model.

The machine learning model supervisor process may be configured, in some embodiments, to identify variables which are or are not under the control of an institution (directly or indirectly), and which are intrinsic factors relating to outside data sets or signals in the data, and In some embodiments, conduct the above re-training iteratively using additional features that are identified as not under the control of the institution.

In some embodiments, a method of detecting an ethical bias in a target machine learning model is disclosed herein. A computing system identifies a target machine learning model for analysis. The computing system identifies a bias variable for testing the target machine learning model against. The computing system generates a first data set. The first data set includes a set of control variables and bias variables for input to the target machine learning model and a first set of outcomes generated by the target machine learning model using the set of control variables and the bias variable. The computing system generates a second data set. The second data set includes the set of control variables, and not the bias variables, for input to the target machine learning model and a second set of outcomes generated by the target machine learning model using only the set of control variables. The computing system fits a generalized linear model to the first data set and the second data set to determine whether an ethical bias is present. The computing system determines that the ethical bias is material using a likelihood ratio test on output generated by the generalized linear model. Based on determining that the ethical bias is material, the computing system notifies a user of the ethical bias being present.

In some embodiments, a non-transitory computer readable medium is disclosed herein. The non-transitory computer readable medium includes one or more sequences of instructions, which, when executed by one or more processors, causes a computing system to perform operations. The operations include identifying, by the computing system, a target machine learning model for analysis. The operations further include identifying, by the computing system, a bias variable for testing the target machine learning model against. The operations further include generating, by the computing system, a first data set. The first data set includes a set of control variables and bias variables for input to the target machine learning model and a first set of outcomes generated by the target machine learning model using the set of control variables and the bias variable. The operations further include generating, by the computing system, a second data set. The second data set includes the set of control variables, and not the bias variables, for input to the target machine learning model and a second set of outcomes generated by the target machine learning model using only the set of control variables. The operations further include fitting, by the computing system, a generalized linear model to the first data set and the second data set to determine whether an ethical bias is present. The operations further include determining, by the computing system, that the ethical bias is material using a likelihood ratio test on output generated by the generalized linear model. The operations further include, based on determining that the ethical bias is material, notifying, by the computing system, a user of the ethical bias being present.

In some embodiments, a system is disclosed herein. The system includes a processor and a memory. The memory has programming instructions stored thereon, which, when executed by the processor, causes the system to perform operations. The operations include identifying a target machine learning model for analysis. The operations further include identifying a bias variable for testing the target machine learning model against. The operations further include generating a first data set. The first data set includes a set of control variables and bias variables for input to the target machine learning model and a first set of outcomes generated by the target machine learning model using the set of control variables and the bias variable. The operations further include generating a second data set. The second data set includes the set of control variables, and not the bias variables, for input to the target machine learning model and a second set of outcomes generated by the target machine learning model using only the set of control variables. The operations further include fitting a generalized linear model to the first data set and the second data set to determine whether an ethical bias is present. The operations further include determining that the ethical bias is material using a likelihood ratio test on output generated by the generalized linear model. The operations further include, based on determining that the ethical bias is material, notifying a user of the ethical bias being present.

The systems being provided are practically implemented in the form of an artificial intelligence/machine learning outcome monitoring framework for computationally estimating bias using a computer implemented approach. The systems can be practically applied to retail risk models, for example, among others. Model outputs being reviewed can, for example, include acquisition and behavior model scores, income prediction, and expenditure predictions, for example, and model decision outcomes can include decision outcomes consisting of (i) application approve/decline, (ii) limit assignment, (iii) transaction pay/no-pay, and iv) credit line increase/decrease (CLI/CLD).

When a model is flagged by the system, the flag can be represented in a data storage as a metadata object, value or set of values corresponding to the model or model version, and the flag can be used by the model supervisor data process as a trigger for potential action, which can include, for example, a flag to allow a model to be shifted into production, a flag to re-train the model, a flag to temporarily deactivate a model, or a flag to continue observing a model performance in more detail (e.g., while there is a potential bias, the sample size may be too small to have it statistically significant to take action). The metadata can include additional derivative data objects indicative of estimate values, % change in approval odds after controlling for relevant factors, gaps in values provided to specific users (e.g., a gap in credit limit), gaps in scores assigned to specific users (e.g., a gap in score). The automated approach herein is adapted to track these differences after controlling for a set of factors (e.g., relevant factors), and in some cases described herein, automatically enforce specific pipeline rules or enforce remedial actions.

The sensitivity of the outcome monitoring and remedial action processes (e.g., the supervisor process) can be tuned, in some embodiments, by adjusting operational parameters to modify thresholds as to when different actions are taken or different models are flagged. In some embodiments, the thresholds are based on weighted averages (e.g., to automatically account for trending and persistent behavior as opposed to ephemeral determinations). The tuning allows for the computing system to practically adjust for balancing model performance and operation in view of potential material biases, while attempting to avoid spurious model de-activations to ensure smooth operation of the system.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a block diagram illustrating back-end computing system, according to example embodiments.

FIG. 3 is a flow diagram illustrating a method of detecting a bias in a machine learning model, according to example embodiments.

FIG. 4A is a block diagram illustrating a computing device, according to example embodiments.

FIG. 4B is a block diagram illustrating a computing device, according to example embodiments.

FIG. 5 is a block diagram illustrating a trigger matrix, according to example embodiments.

FIG. 6 is a block diagram illustrating exemplary output generated by bias detection tool, according to example embodiments.

FIG. 7 is a block schematic of computer implemented system for computationally analyzing a target trained machine learning model.

FIG. 8 is a diagram of an example physical computer server having a special purpose computing appliance, according to some embodiments.

FIG. 9 shows example scores and statistical analysis, according to some embodiments.

FIG. 10 is a set of tables showing example red amber green triggers at different quanta.

FIGS. 11, 12, 13, 14, 15 are charts, showing example statistical analyses for an example protected variable.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Ethical bias in machine learning is a multi-disciplinary subject, which has generated great interest from socioeconomic forums, regulators, governments, and other statutory bodies. A specific computing framework and approach is proposed herein that can be practically implemented in the form of a specially configured computing device that can reside in a data center or be coupled to a message bus to interact with a plurality of models, model versions, and, in some embodiments, a model pipeline process controller configured to selectively couple models to exposed interfaces to allow for interactions with a particular model when the interface is interacted with. The device is configured to attempt to computationally estimate the presence of ethical bias using a set of specific computing processes for interacting with the models, as described in more detail herein. It is important to note that while machine learning models are referenced in this disclosure, other types of models, such as advanced statistical models having refinable parameters and training are also contemplated in this disclosure, and embodiments are contemplated to extend to these variations as well.

An objective of the system is to provide an automated mechanism for tracking and monitoring different types of global bias that can arise over time in respect of computing models and trained architectures, providing a system that can scale and practically operated on a periodic basis in respect of a plurality of available computing models that can be put into production usage through selective API connections.

Visualization approaches are also described herein to assist with providing a decision support interface for fine tuning operations or controlling specific operations of the system, for example, as an optional confirmation step before a model pipeline controller takes steps with respect to model activation/deactivation/re-training. Accordingly, in some variations, data anomalies can be flagged through the analyst's usage of the visualization interface or dashboard.

The examples of ethical bias proposed herein are provided as non-limiting illustrative examples, and may vary from jurisdiction to jurisdiction, or based on target protected characteristics. The example data is simulated or dummy data, and have been prepared for technical testing and research processes, and should not be considered reliable for real-world practical bias testing. This data was prepared for system validation and illustrative purposes only and do not reflect real-world data or real model testing.

While a certain amount of bias may be identified as a result of model analysis, in some embodiments, the quantum of the overall amount of bias may be a triggering factor. For example, different approaches can be taken to assign different trigger types to different normalized amounts of deviance. In this example, a quantum of >20% change in approval odds, a 10% change in a gap in limit, or a 10% change in a score can be used for triggering a “red” flag or alert, a range of 10-20 or 5-10% can be used for triggering an “amber score”, and less than 5-10% can be used for indicating a “green” score. A combined red/amber/green “RAG” score can made from an aggregate of intermediate outputs that combines the significance and materiality scores, for example.

Ethical bias approaches focus on ensuring that machine learning or artificial intelligence driven decisions are reduced or absent from biases against gender, racial groups, ethnicities, nationalities, among others. However, it is important to distinguish ethical bias influenced by an institution or under the control of an institution from signals that are inherent in data and are not under the control or influence of an institution. For example, while there may be differences between different groupings of individuals in terms of re-payment behavior, the payment behavior of individuals occurs regardless of the characteristics of the individual. On the other hand, other features being analyzed may be influenced by activities of the institution, such as, for example, a binary approval/non-approval decision, the determination of how much credit is being made available to an individual given the individual's characteristics, among others.

The set of bias variables to be tested for global bias can be established on a jurisdiction by jurisdiction basis, but as examples, these can include (i) gender and (ii) nationality-groups, subject to data availability and volumes. To avoid spurious results or poor analytical quality, in some cases, there may be a minimum volume for each gender and nationality group, and these can be at least 5% of the total volume of the outcome (in terms of number of applications, accounts, customers, or transactions where an outcome decision is made) subject to a minimum volume of 500 observations. In some examples, a global bias computational test can still be conducted for outcomes that cross the “500 observation” threshold even if it does not constitute 5% of the total volume of the outcome, if deemed appropriate by the model owner driven by size of the portfolio, materiality of model usage or any local jurisdiction specific nuances. Decision to combine certain groups together (e.g., all “non locals” combined together as one group) can be taken with appropriate justification in line with local considerations.

The set of control factors (broad discriminators of risk which financial institutions cannot influence) that can be used for global bias testing can include (i) income and/or (ii) wealth. In case of income estimation models, income and wealth can still be considered as control variables, to be tested on the same monitoring (or out-of-time) data for which actual income is available. The rationale here is that the global bias test of ‘predicted income based on historical data’ is run conditional to the ‘actual income observed after the model has been built’.

The choice could be between conducting the test on the sub-sample where actual income is available or on the whole sample where only estimated income is available for a part of the sample. In the former case, income can be used as a control variable, while in the latter it will be with control variables that can act as proxy for income.

If neither of these control variables are available or meaningful, then proxies which are not impacted by the banks' decision can be considered.

Because machine learning using computer implemented non-explicit programming mechanisms such as the latent spaces of trained machine learning models are difficult to understand from an explain-ability perspective, bias can be incidentally incorporated as signals that enter during the training process, and it is difficult for analysts or developers to catch these biases during the training of the machine learning models.

Accordingly, approaches are proposed herein to provide useful computer implemented systems that are adapted to attempt to computationally estimate, at scale against a potentially large number of models and using a finite amount of computing resources, an estimated level of bias associated with each trained model.

As described herein in variant embodiments, the downstream computer processing activities are also described in relation to invoked functionality that can be invoked or triggered based upon the determined level of bias.

Typically, there are two forms of bias: global bias and individual bias. Global bias typically refers to ascertaining if there is sufficient evidence of bias in a model or model-based decision across a plurality of users or applications. Individual bias typically refers to ascertaining if the score or decision for a single user or application is biased or not, irrespective of other users/applications in the corpus of users.

For the purposes of this disclosure, the focus will be on a model testing computing architecture for generating computer estimated proxy values for global bias that are generated automatically by the system by automatically generating new data sets for running the models, and automatically comparing the outputs with the new data sets to generate the estimation values that can be used as potential proxies for a level of bias, a materiality of the bias, a statistical significance of the value, etc. These estimation values can be normalized and utilized for triggering downstream processes to occur, or for generating visualizations, as described below.

The model testing computing architecture can test multiple features relating to certain characteristics at once, or generate test outputs for individual features, or a combination of individual and multiple feature analysis. For example, the model testing can test a same model for different protected grounds of bias, such as ethnicity, gender, orientation, or combinations of these (e.g., a specific ethnicity combined with a specific gender). As the cause and correlation of bias may not be readily apparent, in some situations, testing for a combination may yield different results than testing individually, and thus, where computing resources are available, the depth and breadth of automated analysis can be controlled.

A control factor, in the context of bias detection (or outcome monitoring) are variable(s) used for outcome differentiation and not disallowed in the relevant jurisdiction for such use. Control variables are expected to be not influenced by a financial institution's decisions, for example. Appropriately chosen control variable(s) is likely to result in more specific bias detection (and lesser false positives). A bias can be caused by a variety of factors and it is important to adjust for few control factors which are the known key drivers of the decisions prior to searching for an outcome bias. At the same time, a bias test that controls for a large number of factors may yield to an erroneous conclusion of no bias. To avoid both of these extremes, approaches are proposed herein to automatically generate data sets that choose a meaningful but limited (low single digit) set of controlling factors which are believed to drive the decision. This can be done on a machine learning data set perturbation basis for automated analysis if no a priori business determinations are made as to which variables are under analysis. Control factors can vary from model to model and can vary by different decisioning strategies. An example of a control factor used in risk is income of the customer. In many markets income may be correlated to gender, legitimate risk differentiation based on income may appear to be caused by gender. Hence, controlling for income would ensure proper identification of gender bias, if it exists.

One or more techniques disclosed herein provides a mechanism for detecting global biases in machine learning models. More specifically, one or more techniques disclosed herein provides a tool that leverages modern visualization methods to identify global biases present in a machine learning model and then may confirm the presence or absence of bias through innovative controlled statistical tests. In this manner, the techniques provided herein improve machine learning processes by identifying biases in machine learning models and adjusting those models to remove the identified bias (e.g., by re-training, rolling back to an earlier snapshot trained version), thus resulting in an improved machine learning model or improved model outputs.

This is especially important as the approaches provided herein describe an automated, computerized mechanism to automatically identify and/or cause remedial action in respect of the specific technical problem associated with iteratively trained machine learning models, whereby unlike explicit programming techniques, it can be difficult for a developer or data scientist to identify inadvertent biases that could occur over time through the training of the machine learning model.

Machine learning models, from a computational perspective, are vulnerable to the presence of confounding variables, where spurious connections may be made and reinforced during the training process.

For example, there may be a hidden bias that is present in the training data or caused by a specific training approach that the developer or data scientist is simply not aware of, and this bias is inadvertently incorporated into a trained machine learning model that is deployed. This can commonly occur, for example, due to issues with a quality/completeness of training data sets (e.g., class imbalances, small training data set sizes), and in certain situations, these biases are unfounded in the underlying “true” signals corresponding to the target output. Because of these biases, the trained machine learning model may unfairly cause inadvertent discrimination against particular classes of individuals in respect of protected characteristics.

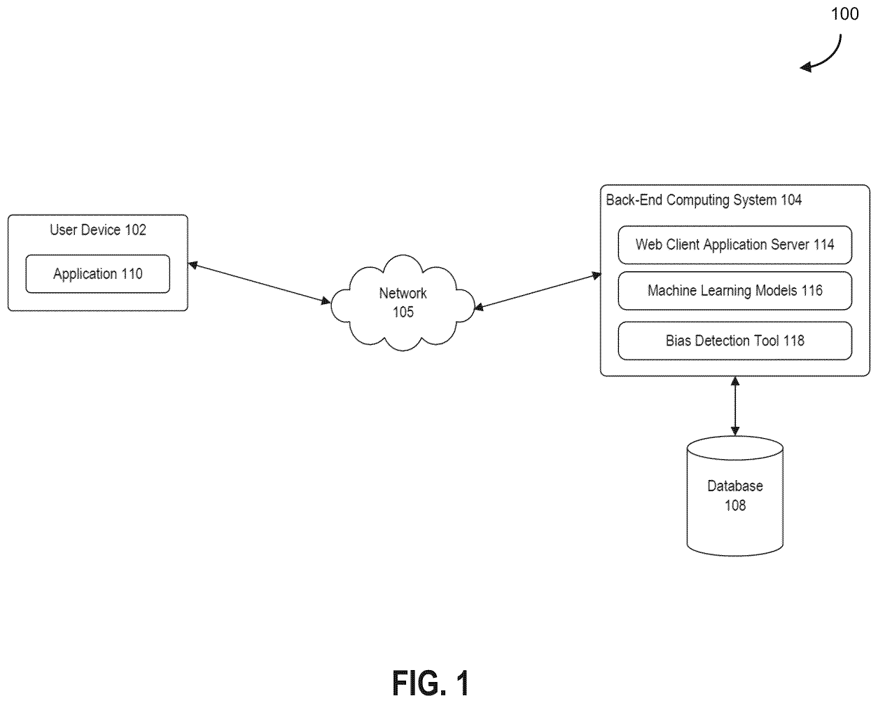

FIG. 1 is a block diagram illustrating a computing environment 100, according to example embodiments. Computing environment 100 may include user device 102 and back-end computing system 104 communicating via network 105. The back-end computing system 104 in the embodiments herein is a machine learning/model outcome analysis engine where the system can be coupled with a message bus or other middleware for interoperation with a model pipeline supervisor data process and corresponding systems, as well as coupling with a plurality of available computing models and their corresponding data representations and computing devices.

The coupling is conducted electronically, and can include data messages that are transmitted over network 105, having payloads such as data sets for conducting inference, machine instruction data sets to control the model pipeline supervisor data process, or a data storage storing metadata objects including tracked values corresponding to different model and model variants, which can then be interrogated (e.g., periodically polled or specifically sent an interrupt signal) to observe the system outputs either for a point in time or over a period of time. In this example, when the model pipeline supervisor data process is determining which model or model variant to make available (e.g., expose via coupling APIs), it can traverse the corresponding metadata for a model or model variant, and determine whether the model should be coupled and made available (e.g., put into production).

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include computer networking arrangement and corresponding devices used to exchange data or information. For example, network 105 may be the Internet, a private data network, virtual private network using a public network and/or other suitable connection(s) that enables components in computing environment 100 to send and receive information between the components of environment 100. The network 105 can be utilized to control external models to generate outputs for analysis by the back-end computing system 104 by using the network to send data sets representative of the generated data sets for analysis, and receiving the data outputs from the models for analysis. After analysis is completed, as noted, network 105 can be utilized to transmit downstream instruction sets to conduct pipeline modifications of models that are being made available or being developed/trained as candidates for eventual promotion for usage as a production model (e.g., externally facing model).

In this computing context, external does not necessarily refer to customers, but can also be production models that are made available to internal computing processes that are utilized to generate intermediate outputs. For example, a model in production can be utilized by a retail store clerk to determine an amount of credit to provide to a customer to assist with a specific purchase in real or near-real time. The retail store clerk's point of sale terminal in this example, would trigger a request for a credit analysis, which sends a data message to a financial institution's back-end computing system 104, which then can then send a request data message to utilize a back-end model for inference to determine credit availability, the model generating an output value that can ultimately be returned to the point of sale terminal for consummating the transaction using available credit, if any.

As noted herein, a specific technical challenge with computing models, especially machine learning models, is that bias may creep in during training intervals, even if no bias was intended, and the systems described herein are provided as an attempt to computationally provide a safeguard mechanism against this type of bias creep, among others, automatically flagging or taking remedial data processes with respect to the available data models. While there can be more complexity to the data stored in the representations and data objects used for flagging or tracking potentially problematic models and the reasons thereof, a simplified approach can include creating triggers based on a “green”, “amber” and “red” thresholding approach.

User device 102 may be in communication with back-end computing system 104 via network 105. User device 102 may be operated by a user. For example, user device 102 may be a mobile device, a tablet, a desktop computer, or any computing system having the capabilities described herein. In some embodiments, users may include, but are not limited to, individuals such as, for example, developers or employees of an entity associated with back-end computing system 104. In some embodiments, users may include, but are not limited to, individuals, such as, for example, subscribers or customers of an entity associated with back-end computing system 104.

User device 102 may include application 110. Application 110 may be representative of an application associated with back-end computing system 104. In some embodiments, application 110 may be a standalone application associated with back-end computing system 104. In some embodiments, application 110 may be representative of a web-browser configured to communicate with back-end computing system 104. In some embodiments, user device 102 may communicate over network 105 to request a webpage, for example, from web client application server 114 of back-end computing system 104. For example, user device 102 may be configured to execute application 110 to test a target machine learning model for biases and/or to train or develop a the target machine learning model once a bias is detected. The content that is displayed to user device 102 may be transmitted from web client application server 114 to user device 102, and subsequently processed by application 110 for display through a graphical user interface (GUI) of user device 102.

Back-end computing system 104 may include web client application server 114, machine learning models 116, and bias detection tool 118. Bias detection tool 118 may be comprised of one or more software modules. The one or more software modules may be collections of code or instructions stored on a media (e.g., memory of back-end computing system 104) that represent a series of machine instructions (e.g., program code) that implements one or more algorithmic steps. Such machine instructions may be the actual computer code the processor of back-end computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Machine learning models 116 may be representative of one or more machine learning models used by an entity associated with back-end computing system 104. For example, when back-end computing system 104 is a financial institution, such as a bank, machine learning models 116 may include various machine learning models trained to make various financial decisions. In some embodiments, machine learning models 116 may include a machine learning model trained to approve or decline a customer's credit card application, a machine learning model trained to approve or decline a customer's loan application, a machine learning model trained to approve or decline a customer's mortgage application, and the like.

Bias detection tool 118 may be configured to analyze a given machine learning model of machine learning models 116 to determine whether the machine learning model exhibits a bias.

The bias detection tool 118 can be a specially configured server coupled to a messaging bus or computing interfaces and may receive, as an input, trained machine learning models 116 for analysis, in the form of data objects through the interfaces or the messaging bus. In a variant approach, instead of receiving the trained machine learning models 116 through a messaging bus or interfaces, instead the bias detection tool 118 is configured for controlling operation of the trained machine learning models 116 by being able to provide new input data sets and receive output data sets generated by the trained machine learning models 116. As described herein, the bias detection tool 118 is configured to operate the trained machine learning models 116 using different variations of input data sets (e.g., with different combinations of features) so that separate outputs can be automatically generated and compared using linear model approaches described herein in various embodiments.

In some embodiments, bias detection tool 118 is configured to interoperate with a machine learning model supervisor process to automatically generate control signals to change operational characteristics of select trained machine learning models 116. These operational characteristics include conducting re-training, reverting to an older snapshot version, and further, the machine learning model supervisor process may be further configured to conduct a re-test using the bias detection tool 118, and only “spin up”/deploy for production purposes a replacement version of select trained machine learning models 116 if the replacement version is able to overcome a test from the bias detection tool 118. This test can include, for example, an automated determination that there is no material ethical bias through the approaches described herein.

The machine learning model supervisor process may change the training process or the selected data sets being used to train a particular model during the re-training, and this changed training process may include perturbations based on available control levers associated with machine learning training. In some embodiments, the machine learning model supervisor can continually perturb or generate multiple candidate replacement models and select the candidate replacement model that ultimately passes a re-test using the bias detection tool 118.

As indicated above, biases in machine learning may take one of two forms: a global bias or an individual bias. Bias detection tool 118 may be configured to focus on identifying whether a given machine learning model exhibits a global bias, i.e., whether a machine learning model is biased across a corpus of customers or users. For example, bias detection tool 118 may analyze output generated by a given machine learning model to generate a computer-based determination score representative of an estimation of whether the machine learning model is unintentionally biased, the computer generated score representing an output of a computational process generated from operation of the machine learning model with different input sets and conducting a computer comparison of the output of the machine learning model, the comparison, including, but not limited to, a linear model used to determine a level of difference between the different input sets. For example, from the perspective of practical implementation, statistical analysis system (SAS) scripts can be used to implement this comparison and automatically executed to generate the estimation, and ultimately the determination. Two computing approaches and corresponding algorithms that can be used for the automatic determination (e.g., the test) are (a) GLM estimation and (b) LRT. The GLM estimation uses maximum likelihood estimations which is a statistical algorithmic approach. The LRT statistic is a direct output from the LM estimates of likelihood—large sample distribution of LRT is chi-squared, for example.

A benefit of computer automation is that the models can be tested at different iterations and training versions, and automatic results can be generated to be used as gatekeeping controls as to whether a particular model (or version thereof) should be deployed, or whether a particular model should be re-trained, or removed from usage. Automatic estimation as proposed herein may be less accurate than other approaches, but the approaches proposed herein provide a technical tradeoff between computational complexity and practical scalability. The system can be used as an early warning indicator that runs as a nightly batch process, for example, against all of the models or a subset of models that are either used in a production pipeline or “on deck” to be deployed onto a production pipeline. The production pipeline can be handled automatically by a supervisor process that generates control signals to swap in or swap out models from deployment, and this “swapping in/out” can include coupling a model (or re-assigning coupling) to exposed application programming interfaces (APIs) to handle new incoming calls for model inference.

Another important technical aspect to consider is that in certain models, such as those used in cybersecurity, fraud detection, the models are trained in real-time (e.g., “online training”) as there is a focus on being able to adapt to real-world changes. As the training is done in real-time or near-real time, ethical bias considerations become more prevalent because the latent space of models can, unintentionally, shift from a relatively unbiased latent space to a biased latent space, for example, as new data is ingested. This can be a function of the new data itself, issues with the data source, or imbalances in distribution of data that are provided. Because the latent models themselves are difficult from an explainability perspective relative to explicitly trained computing (e.g., where a computer programmer is explicitly writing rules), the “rules” are represented as weights and parameters that are shifting over time. The approach provided herein is a useful computational tool that can practically run as a batch process coupled to the supervisor process to continually generate computer estimations of bias that can be investigated (in the less material examples), or in higher materiality examples, automatically lead to automatic downstream functions being invoked for model rejection, model reversion, and/or model re-training. This is a useful computational safeguard that is practically implemented in the form of a special purpose computing appliance that can be housed and reside within a data center and operate alongside the supervisor process.

Unintentional bias may include, but is not limited to, bias towards gender, race, ethnicity, nationality, and the like. Once bias detection tool 118 detects a bias, a developer may be prompted, or in some cases, as described herein, a supervisor process may be controlled to adjust the machine learning model and/or retrain the machine learning model for re-test and potential deployment as a replacement. This re-test could be contemplated as a second and further stage analysis, for example, and as there can be a potentially unlimited number of stages of downstream re-test and analysis, in some embodiments, the further stages beyond the first stage can include the system being configured to incrementally add additional individual variables for re-training based, for example, on a prioritized ranking of variables that can be determined locally based on variable features having a largest impact on the output. Accordingly, the model can be incrementally “fine tuned” with incremental stages as a more specific approach to re-tune models to reduce unintentional bias while attempting to avoid over-utilization of computing resources for model re-training and subsequent re-testing.

The bias detection tool 118, in a further variant embodiment, may be configured to include an additional testing stage where after a bias is detected, the bias is re-tested to assess whether the bias is present to a variable in the control of the institution, or is the bias present due to a variable outside of the control of the institution. In this variation of the bias detection tool 118, the bias detection tool 118 conducts a pair of analyses, using two different combinations of control and bias variables being identified, which could include mirrored versions of the control and bias variables. For example, a first analysis can be conducted using identified control and bias variables as described herein, and a subsequent re-test can be conducted using the bias detection tool 118 again using one or more of the control and bias variables swapped. Once controlled for a particular variable, it may indicate that the same trained model, as re-tested, may no longer have the bias, and this could be utilized as an approach as a potential proxy attempt to pinpoint a variable that is a causal basis for a bias. If the variable being identified in this approach is a variable outside of the control or influence of the institution, in this variation, while the model may be flagged as biased, the model may nonetheless be used as the bias is not due to the influence of the institution.

In some embodiments, back-end computing system 104 may maintain or be in communication with database 108. In some embodiments, database 108 may maintain data used for training machine learning models 116. In some embodiments, database 108 may maintain data used for generating decisions using machine learning models 116. For example, database 108 may include information related to customers or subscribers of an entity associated with back-end computing system 104. As the range of outputted score of estimations of ethical bias may varies across scorecards, in some embodiments, to remove any scope of the global bias test getting impacted by the range of the score, the scores are first converted to the ‘base score and PDO’ prior to calculation of materiality threshold. For scores where it is not feasible to readily converted as above, internal performance ‘bad’ data can be considered to perform the conversion.

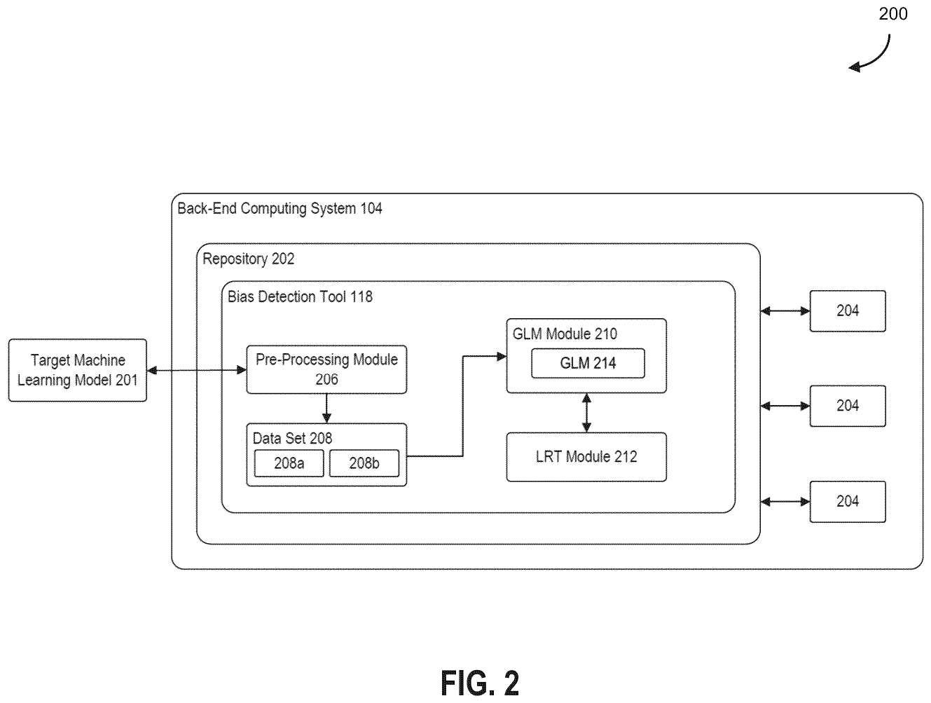

FIG. 2 is a block diagram illustrating back-end computing system 104, according to example embodiments. As shown, back-end computing system 104 includes repository 202 and one or more computer processors 204.

Repository 202 may be representative of any type of storage unit and/or device (e.g., a file system, database, collection of tables, or any other storage mechanism) for storing data. Further, repository 202 may include multiple different storage units and/or devices. The multiple different storage units and/or devices may or may not be of the same type or located at the same physical site. As shown, repository 202 includes at least bias detection tool 118.

Bias detection tool 118 may include pre-processing module 206, generalized linear module (GLM) module 210, and likelihood ratio test (LRT) module 212. Each of pre-processing module 206, GLM module 210, and LRT module 212 may be comprised of one or more software modules. The one or more software modules are collections of code or instructions stored on a media (e.g., memory of back-end computing system 104) that represent a series of machine instructions (e.g., program code) that implements one or more algorithmic steps. Such machine instructions may be the actual computer code the processor of back-end computing system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Pre-processing module 206 may be configured to prepare a data set for analysis. In some embodiments, pre-processing module 206 may communicate with database 108 and a target machine learning model 201 to generate data set 208. For example, assume that target machine learning model 201 for analysis is trained to grant or deny a customer's credit card application. Pre-processing module 206 may utilize target machine learning model 201 to generate a plurality of outputs for a plurality of customers based on customer information in database 108. Pre-processing module 206 may aggregate the outputs generated by target machine learning model 201 and the variables input to target machine learning model 201 that were used to generate the outputs to generate data set 208. A granting or denial process can be based on models (e.g., scorecard) that estimates the future probability of default of an account or application. This is usually developed on a past ‘snapshot’ data which has a 12 month history of each account prior to the snapshot month; and a 12 month default performance of each account post the snapshot. The former are the independent variables of the model, while the latter are the dependent variables. Once the ML (or traditional statistical) model has been built, it is applied on ‘live’ applications/accounts to produce a ‘probability of default’ represented through a ‘score’. If the score of the applicant is above a predefined threshold, this would lead to a ‘denial’ of credit. There can be multiple thresholds for various segments of data. The final grant or denial decision may additionally depend on a range of policies and regulations on top of the scorecard approve/decline.

In some embodiments, data set 208 may include data set 208 and data set 208b. For example, in some embodiments, pre-processing module 206 may generate two data sets: first data set 208a and second data set 208b. First data set 208a may include all factors and the outcomes generated by target machine learning model 201 using those factors. Second data set 208b may include all factors, except for a bias factor, and the outcomes generated by target machine learning model 201 using those factors. The bias factor may be representative of the factor for which bias detection tool 118 is determining whether a bias is present. Using a specific example, assume the bias factor being tested is gender. First data set 208a may include all factors, including the gender factor, and the outcomes generated using all factors. Second data set 208b may include a subset of all factors, i.e., all factors but the gender factor, and the outcomes generated using the subset of factors.

In some embodiments, pre-processing module 206 may identify control variables in the data. Control factors may refer to those factors upon which discrimination or bias may be allowed. Continuing with the foregoing examples, in the case of approving or denying a credit card application, discrimination may be allowed across several variables, such as, but not limited to salary or income.

GLM module 210 may be configured to apply a generalized linear model (GLM) to data set 208. GLMs are a family of statistical models which help break down a target machine learning model (e.g., target machine learning model 201) as a linear combination of parameters. In some embodiments, GLM module 210 may utilize GLM 214. GLM 214 may include an exponential family of probability distributions, a linear prediction η=Xβ, and a link function g such that E(Y|X)=μ=g⁻¹(η), where X corresponds to predictors or factors in data set 208 and β corresponds to parameters of predictors X. Generally, the better the factors explain the data, the better the GLM can be fit to the data, which can be measured by a statistical function that measures the goodness of fit between GLM 214 and data set 208.

Generally, GLM module 210 may perform GLM 214 to each of first data set 208a and second data set 208b. In other words, GLM module 210 may perform GLM 214 to a data set that includes the bias factor and a data set that does not include a bias factor in order to measure how well variation in the data may be explained by target machine learning model 201 with and without the bias factor. Performing GLM refers to “estimating/fitting” the GLM model, and the models may include further explanatory power of the independent variables as, for example, in an ANOVA. The core computing approach for fitting a GLM model is a Maximum Likelihood Estimation. This may be in the form of a Newton algorithm or in some cases be achieved through IRLS (iteratively reweighted least squares) based on an information matrix data structure.

In some embodiments, GLM module 210 may set the outcome (e.g., credit card approved/credit card denied) as the dependent variable and the bias variable (e.g., gender) and control factors (e.g., income, wealth, salary, etc.) as independent variables. GLM module 210 may apply GLM 214 in this manner to each of first data set 208a (e.g., all factors) and second data set 208b (e.g., factors without the bias variable).

LRT module 212 may be configured to analyze the results generated by GLM module 210. For example, LRT module 212 may perform a likelihood ratio test on the output generated by GLM module 210 to confirm the presence or absence of a global bias for the bias variable after adjusting for the effects of the control variables. In the embodiments, LRT module 212 may test the statistical significance of a bias variable using a log-based function. For example, LRT module 212 may identify a statistical significance, A, of the bias variable using:

$$Λ = 2 * log \frac{likelihood ( Model with Bias Variable \vert Data )}{likelihood ( Model without Bias Variable \vert Data )}$$

Applying LRT to the above GLM 214 yields:

$$Λ = 2 * log \frac{likelihood ( X {β}_{bias} + X {β}_{control} \vert Data )}{likelihood ( X {β}_{control} \vert Data )}$$

There are several benefits of using LRT over an underlying GLM. For example, GLM 214 may be conducted using a series of systematic approaches for a large array of distributions (e.g., known as the exponential family of distributions.) For example, whether the outcome of the target machine learning model is binary (e.g., approve/decline for credit card applications) or continuous (e.g., proposed credit limit assigned to approved applications), GLM 214 may be able to model and estimate the outcomes in a standardized way using a variety of programming languages and software (e.g., R, Python, SAS, MATLAB, etc.). The LRT also provides a test for parametric models. Thus, bias detection tool 118 can be deployed across a flexible range of computing environments.

In some embodiments, such as in the case where there may be statistical evidence of global bias, the materiality of the quantum of bias may be measured by the adjusted difference in outcome (e.g., the gap between the average credit limit assigned to females and the average credit limit assigned to males). Bias detection tool 118 may recommend that this adjusted gap be standardized by the overall average level of the outcome (e.g., credit limit) and an empirical threshold applied to the percentage change to arrive at a trigger for materiality of the observed bias. The phrase “adjusted difference in outcome” is a statistical reference. For example, a GLM model fit would produce a coefficient of the bias variable—this coefficient is indeed the “adjusted difference in outcome”. One case where this would need a transform is for a binary outcome such as approve/decline decisions.

A statistical test with a control factor may be used to measure the effect of a factor on a particular machine learning generated outcome after adjusting for the effects of other factors, which may reasonably be assumed to have an impact on the outcome. For example, the credit approval rates of males versus females can reasonably be expected to be driven by their differing incomes. In such context, the problem here is to test if there is evidence of a gender bias in credit approval which cannot be explained by the differing income levels because, for example, income is a widely accepted differentiator of risk to measure the customer's willingness and ability to pay. In the context of GLM 214, this can be readily achieved by using income as a predictor, so that LRT module 212 may measure how much of the variability in the data is explained by gender after adjusting for the variation due to income.

Based on the detected observed bias, a developer may adjust target machine learning model 201. In some embodiments, bias detection tool 118 may generate detailed reports based on the analysis.

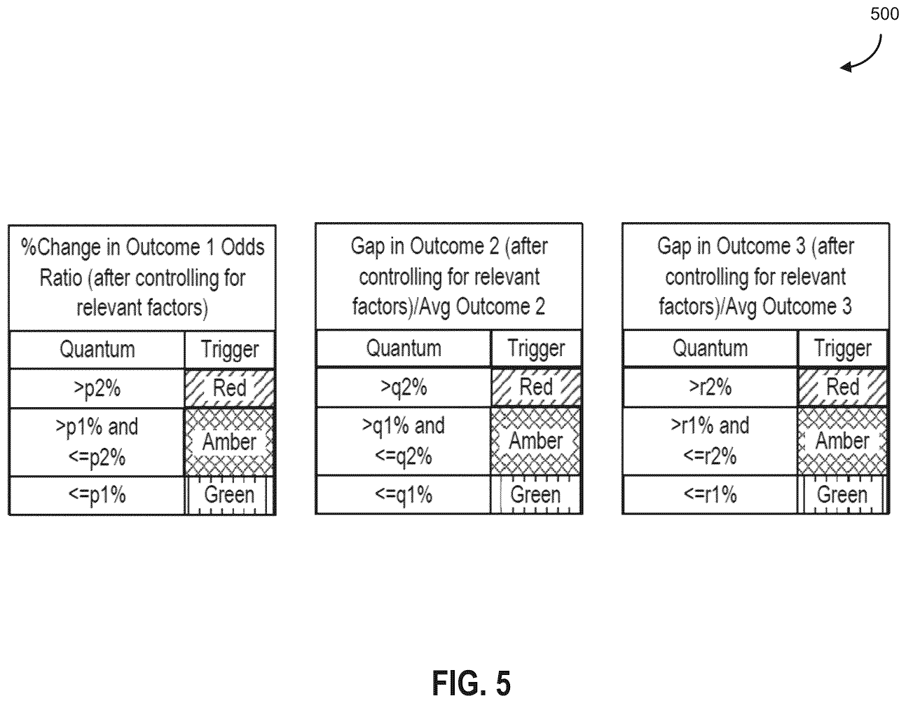

FIG. 5 is a block diagram illustrating a trigger matrix 500, according to example embodiments. Although trigger matrix 500 is shown in black and white, those skilled in the art understand that trigger matrix 500 may be representative of a red, amber, green (RAG) trigger matrix. Accordingly, rather than show the colors, trigger matrix 500 merely denotes each color (red, amber, green) and provides a different fill effect for each color.

As shown, for the p-value, red may represent a strong evidence of bias; amber may represent a moderate evidence of bias; and green may represent no evidence of bias.

For the materiality of bias (i.e., q-value), red may represent a material bias; amber may represent a moderate material bias; and green may represent non-material bias.

In some embodiments, the final outcome or RAG of the bias may be green if the p-value is green. In some embodiments, the final outcome or RAG of the bias may be material if p-value is not green.

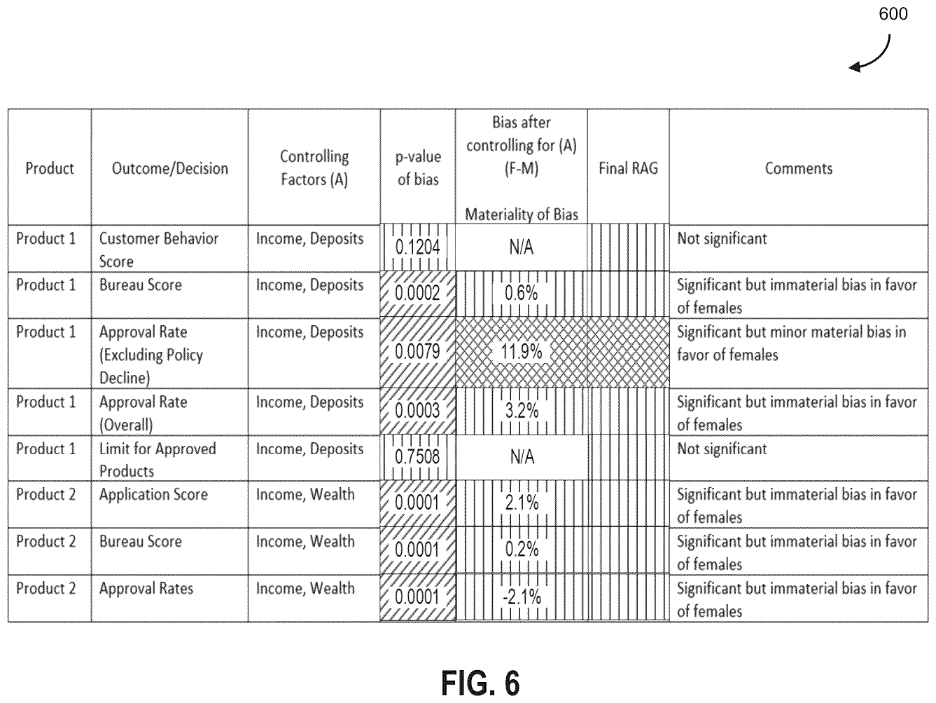

FIG. 6 is a block diagram illustrating exemplary output 600 generated by bias detection tool 118, according to example embodiments. As shown, output 600 may represent an exemplary global bias test performed for different customer outcomes after adjusting for the allowed differentiators of risk (e.g., control factors). As shown, output 600 includes the p-value of the bias and are “color-coded” in accordance with trigger matrix 500 discussed above in conjunction with FIG. 6.

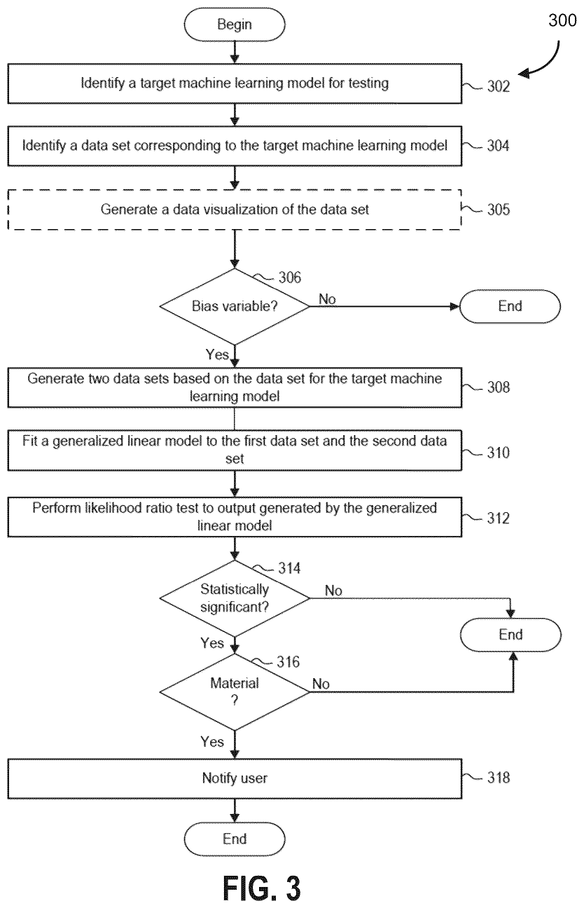

FIG. 3 is a flow diagram illustrating a method of detecting bias in a target machine learning model, according to example embodiments. Method 300 may begin at step 302.

At step 302, back-end computing system 104 may identify a target machine learning model for testing. In some embodiments, bias detection tool 118 may identify a target machine learning model for testing based on an automated and routine maintenance of machine learning models 116. In some embodiments, bias detection tool 118 may identify a target machine learning model for testing based on a request received from user device 102 via application 110. In some embodiments, bias detection tool 118 may further identify a bias for which to test. Example biases may include, but are not limited to, gender, age, ethnicity (and may vary from jurisdiction to jurisdiction).

At step 304, back-end computing system 104 may identify a data set corresponding to the target machine learning model. For example, pre-processing module 206 may identify all data in database 108 that is typically input to the target machine learning model to generate a prediction.

In some embodiments, method 300 may include step 305. At step 305, back-end computing system 104 may generate a data visualization of the data set. In some embodiments, the data visualization generated by back-end computing system 104 may take the form of a box and whisker plot. Such data visualization may assist an operator or end user in preliminary identifying a bias variable is present.

At step 306, back-end computing system 104 may determine whether a bias variable is present in gender, race, ethnicity, nationality, and the like. For example, pre-processing module 206 may analyze the data in database 108 that is typically input to the target machine learning model to determine whether the target machine learning model can be analyzed to identify bias towards that variable. If, at step 306, pre-processing module 206 determines that the bias variable is not present, then method 300 ends as there is no bias to test for. If, however, at step 306, pre-processing module 206 determines that the bias variable is present, the method 300 proceeds to step 308.

At step 308, back-end computing system 104 generates two data sets for the target machine learning model. In some embodiments, pre-processing module 206 may generate two data sets: a first data set and second data set. The first data set may include all factors and the outcomes generated by target machine learning model using those factors. The second data set may include all factors, except for the tested bias factor, and the outcomes generated by target machine learning model using those factors. The bias factor may be representative of the factor for which bias detection tool 118 is determining whether a bias is present.

At step 310, back-end computing system 104 may fit a generalized linear model to the first data set and the second data set. To fit the generalized linear model, bias detection tool 118 may set the outcome (e.g., credit card approved/credit card denied) as the dependent variable and the bias variable (e.g., gender) and control factors (e.g., income, wealth, salary, etc.) as independent variables.

At step 312, back-end computing system 104 may perform a likelihood ratio test to output generated by the generalized linear model. For example, bias detection tool 118 may perform a likelihood ratio test on the output generated by the generalized linear models to confirm the presence or absence of a global bias for the bias variable after adjusting for the effects of the control variables.

At step 314, back-end computing system 104 may determine whether a statistically significant bias is present. For example, bias detection tool 118 may test the statistical significance of a bias variable using a log-based function. If, at step 314, bias detection tool 118 determines that the bias is not statistically significant, then method 300 ends. If, however, bias detection tool 118 determines that the bias is statistically significant, then method 300 proceeds to step 316.

At step 316, back-end computing system 104 may determine whether bias is material. For example, bias detection tool 118 may measure the materiality of the quantum of bias using an adjusted difference in outcome. In some embodiments, the materiality may be determined in accordance with a trigger matrix, such as trigger matrix 500 discussed above in conjunction with FIG. 5. If, at step 316, bias detection tool 118 determines the bias is not material, then method 300 ends. If, however, bias detection tool 118 determines that the bias is material, then method 300 proceeds to step 318.

At step 318, back-end computing system 104 may notify a developer or user of the detected bias.

In a further example, describing the above steps in an end to end example, at step 302, the Application (or acquisition) model (or scorecard) which is a logistic regression based model deployed for ‘live’ decisioning in portfolio A of country C. At step 304: A cohort of all incoming application for credit cards in portfolio A of country C in the month of January 2024 is observed in a data set. Each row of the data consists of an application.

It will have one column representing the bias variable, which is gender or nationality-groups (say the 6 continents). It will have one column representing the score and another approve decline decision for each row. There will be one column for each control variable. This means a column representing the income of each applicant, a column representing wealth balances, and another representing bureau payments.

At step 305, the system generates a visualization of the two outcome variables (score and approve/decline) against the gender and nationality-groups. Similarly, it allows a visualization to support observation at a level of the distribution of control variables. This often helps with identifying data anomalies as well as form initial hypotheses on if/where global bias exists.

At Step 306: Some markets (such as the US) have regulations precluding institutions from storing information on bias variables like gender or nationality.

For Steps 308, 310, 312, one can refer to step 304 above for data. In some embodiments, the dataset 208b is not usually explicitly prepared. Rather the GLM module is ‘told’ that the variable whose impact is being tested is the ‘gender’ and entire 208a is passed to it. However, in some cases, the two models may need to be explicitly fit by the analyst in which case 208b would be needed which is 208a without the bias variable (gender).

The GLM results, among other things produce the coefficient of the gender variable as well as the LRT output. (sometimes the LRT output is not produced by default, say in SAS, where the argument ‘TYPE3’ is needed to produce it. In other cases, say in Python StatsModel, the two GLMs may needs to be explicitly fit and LRT calculated by taking the difference of the log-likelihood.

At Steps 314, 316: If the test is statistically significant, then a materiality check if performed to ascertain the severity from a risk management point of view. The Global Bias test would be conducted once with score as an outcome and separately with the approve/decline as an outcome. Any breach in the global bias test can be determined based on the output datasets generated by the system. These can be investigated and reports can be published to a model sponsor for review or downstream automatic remediation steps.

As described herein, as a first step, the system can be configured for using bureau variables (which are not impacted by any banks' decisions) as control variables and rerunning the bias test. This may help identify if the apparent breach of global bias test is due to an underlying difference in creditworthiness between ‘group’s of customers due to such drivers of risk. The term ‘group(s) of interest’ has been used in this document to refer to socio-economic group(s) protected in a jurisdiction or other group(s) of interest against whom bias is to be ascertained, but this may vary from jurisdiction to jurisdiction or social contexts. An example of a group of interest is ‘gender’ where a bias could lead to potential reputational risk. However, it is important to note that this document is a technical document relating to a specific computational model approach, and is not a policy document, and thus other factors may be under consideration and nothing in this document should be considered specific policy objectives.

If the step above does not explain the breach for an outcome (e.g., approve/decline) and if any additional external outputs (e.g., bureau score) are used in conjunction with the model to determine the outcome (e.g., approve/decline rule), then a conditional test may be performed as follows: use that external decision (e.g., bureau score) as an additional control factor and rerun the test. If the breach is removed, then it can be determined that the bias was driven by that external decision (e.g., bureau score). Based on the investigation results, a clear plan leading to a possible recommendations with proper justification can be prepared. An outcome is defined as the final decision taken with respect to a customer or a transaction. Intermediate decisions, like the value of the score, can also considered ‘outcome’ for the purpose of this document. The outcome or decision can be of two types: categorical or numeric. An example of a categorical outcome is the use of a score to approve or decline an application for a credit card. An example of a numeric outcome is the maximum loan amount that a customer is eligible for based on her/his score. In practice, numeric outcomes can be discretized into a set of categorical outcomes.

As described herein, in some embodiments, the architecture is configured to automatically be triggered to take automatic action to stop using a model immediately, conduct a re-training and reversion to use an older model, or flag a model operation for increased observation (e.g., to allow the continued use of the model but with additional safeguards in place, or in some cases, if approved by an analyst after being automatically flagged, allowing for continued usage—this is important in situations where is a justification for continued usage or the outcome monitoring approach proposed herein has been noted to track a spurious relationship).

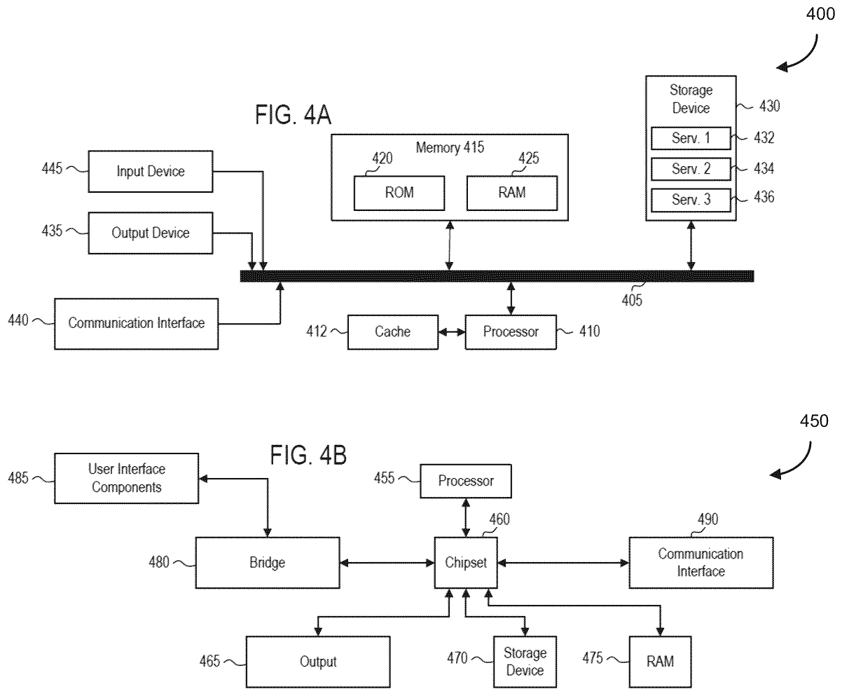

FIG. 4A illustrates a system bus architecture of computing system 400, according to example embodiments. System 400 may be representative of at least a portion of back-end computing system 104. One or more components of system 400 may be in electrical communication with each other using a bus 405. System 400 may include a processing unit (CPU or processor) 410 and a system bus 405 that couples various system components including the system memory 415, such as read only memory (ROM) 420 and random-access memory (RAM) 425, to processor 410. System 400 may include a cache of high-speed memory connected directly with, in close proximity to, or integrated as part of processor 410. System 400 may copy data from memory 415 and/or storage device 430 to cache 412 for quick access by processor 410. In this way, cache 412 may provide a performance boost that avoids processor 410 delays while waiting for data. These and other modules may control or be configured to control processor 410 to perform various actions. Other system memory 415 may be available for use as well. Memory 415 may include multiple different types of memory with different performance characteristics. Processor 410 may include any general-purpose processor and a hardware module or software module, such as service 1 432, service 4 434, and service 3 436 stored in storage device 430, configured to control processor 410 as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction with the computing system 400, an input device 445 may represent any number of input mechanisms, such as a microphone for speech, a touch-sensitive screen for gesture or graphical input, keyboard, mouse, motion input, speech and so forth. An output device 435 may also be one or more of a number of output mechanisms known to those of skill in the art. In some instances, multimodal systems may enable a user to provide multiple types of input to communicate with computing system 400. Communications interface 440 may generally govern and manage the user input and system output. There is no restriction on operating on any particular hardware arrangement and therefore the features here may be substituted for improved hardware or firmware arrangements.

Storage device 430 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 425, read only memory (ROM) 420, and hybrids thereof.

Storage device 430 may include services 432, 434, and 436 for controlling the processor 410. Other hardware or software modules are contemplated. Storage device 430 may be connected to system bus 405. In one aspect, a hardware module that performs a particular function may include the software component stored in a computer-readable medium in connection with the necessary hardware components, such as processor 410, bus 405, output device 435, and so forth, to carry out the function.

FIG. 4B illustrates a computer system 450 having a chipset architecture that may represent at least a portion of back-end computing system 104. Computer system 450 may be an example of computer hardware, software, and firmware that may be used to implement the disclosed technology. System 450 may include a processor 455, representative of any number of physically and/or logically distinct resources capable of executing software, firmware, and hardware configured to perform identified computations. Processor 455 may communicate with a chipset 460 that may control input to and output from processor 455. In this example, chipset 460 outputs information to output 465, such as a display, and may read and write information to storage device 470, which may include magnetic media, and solid-state media, for example. Chipset 460 may also read data from and write data to RAM 475. A bridge 480 for interfacing with a variety of user interface components 485 may be provided for interfacing with chipset 460. Such user interface components 485 may include a keyboard, a microphone, touch detection and processing circuitry, a pointing device, such as a mouse, and so on. Inputs to system 450 may come from any of a variety of sources, machine generated and/or human generated.

Chipset 460 may also interface with one or more communication interfaces 490 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 455 analyzing data stored in storage device 470 or RAM 475. Further, the machine may receive inputs from a user through user interface components 485 and execute appropriate functions, such as browsing functions by interpreting these inputs using processor 455.

It may be appreciated that example systems 400 and 450 may have more than one processor 410 or be part of a group or cluster of computing devices networked together to provide greater processing capability.

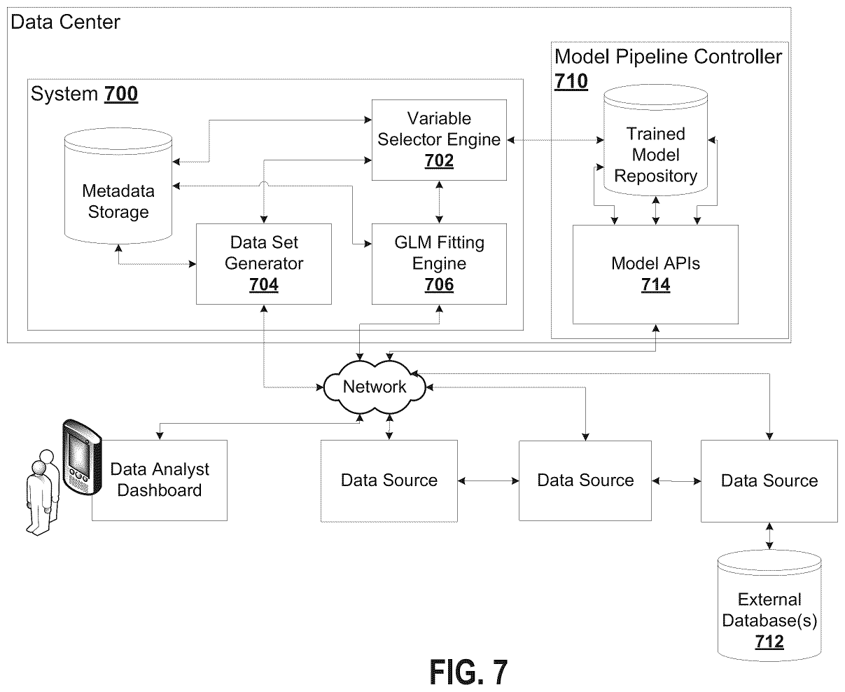

FIG. 7 is a block schematic of computer implemented system for computationally analyzing a target trained machine learning model. The system 700 is configured to couple with a plurality of hosted models through application programming interfaces, sending instructions to run the trained models using generated input data sets and to receive in turn an output data set generated by the model operating in an inference mode.

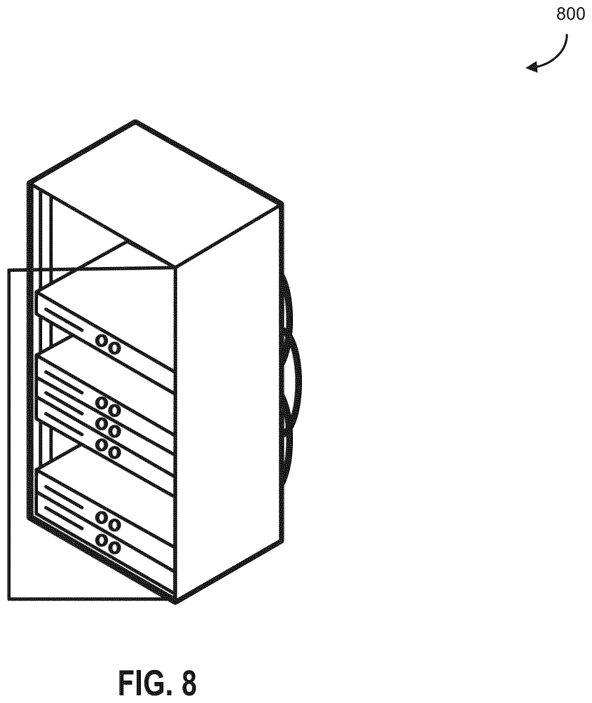

FIG. 8 is a diagram of an example physical computer server having a special purpose computing appliance 800, according to some embodiments. The example physical computer server can be configured using machine interpretable instructions stored on non-transitory computer readable media (software program products affixed to a physical form) and executed on one or more physical computing processors of the system.

The system 700 can be a server residing in a data center having the special purpose computing appliance 800 and coupled as a special purpose machine/computing appliance that operates as an overseer process with respect to the plurality of hosted models, operating in conjunction with a model pipeline control process in providing automatic control of which models are made available through the model pipeline control process to be exposed for production usage through coupling with corresponding application programming interfaces. For example, there can be models for usage for binary decision making (e.g., approval/non-approval decisions), generating continuous outputs (e.g., sizing an available credit limit), and these models can be used both internally and externally. The special purpose computing appliance 800 can be provided on specially configured software operating on dedicated physical hardware processors and memory, where the special purpose computing appliance 800 is provided as a rack-mounted appliance that resides in a server tower/appliance rack in a data center.

The special purpose computing appliance 800 can thus be connected to the network through the message bus, and communicate with external systems and servers hosting trained models. The special purpose computing appliance 800, in some embodiments, maintains the metadata storage mechanism (e.g., a reference table) that stores timestamped data structures and data records corresponding to each trained model and bias estimation/materiality values. The special purpose computing appliance 800 is configured to operate periodically (e.g., on a daily/weekly/monthly basis) or based on process triggers (e.g., as part of a model verification process triggered before any shift from test to production), or both.

In some embodiments, the special purpose computing appliance 800 is configured to directly control the downstream model controller process by sending interrupt messages when a trigger condition is determined, causing changes to model operation. In another embodiment, instead the downstream model controller process interrogates the metadata storage mechanism periodically instead as part of a batch review process and the downstream model controller process operates to cause changes to model operation based on the metadata values stored thereon the special purpose computing appliance 800.

The system 700 can include a variable selector engine 702 that is configured to select which variables will be designated as control and which as bias variables, a data set generator 704 that generates the first and second input data sets using data set generator described below based on the designated control and bias variables, a linear model (GLM) fitting engine 706 that is configured to conduct model fitting and generate corresponding outputs that are representative of computational estimates of bias and/or materiality as proposed in various embodiments herein. The engines can be implemented in the form of interoperating code modules operating on specific computer hardware, or in some embodiments, as distinct processors operating on differently optimized hardware that are coupled together.

There can be hundreds of models, and different sub-variants of the models, for example, trained with different underlying training data, or maintained at different snapshots of time in the event that a rollback is required, and in some embodiments, these models can be hosted on various computing architecture. The trained models themselves can be represented in the form of data structures storing trained parameters.

The system 700 is specifically adapted to generate estimation values representative of a potential ethical bias present in the target trained machine learning model. The system 700 can conduct this task on demand, periodically (e.g., based on a schedule), or as triggered (e.g., based on when a trigger condition is met, such as when a model is being proposed for production usage). The system 700 can be configured to operate as part of a back-end batch process, for example, operating during a systems maintenance period (e.g., overnight), so that there is a increased window of available computing time and/or resources.

The system 700 is configured to retrieve or otherwise select a target trained model for analysis, and a first step includes segregating input variables into control variables and bias variables. As there can be different potential options for variable selection, especially with highly complex and multi-dimensional models, in a specific embodiment where the system operates on a periodic basis, and selects different combinations of variables for analysis. For example, the system 700, if scheduled to operate periodically, can analyze different variables during different operation cycles (or randomly selected variables), so that the computational burden can be spread across different periods (e.g., night 1=gender, night 2=ethnicity).

At least two test input data sets are generated using a combination of control variables and bias variables, and the two test input data sets allow for process, the first data set and the second data set are then used as inputs into the trained target machine learning model operating in inference mode to generate a corresponding first set of output data and a second set of output data.

The first set of output data and the second set of output data are automatically generated specifically to observe differences in output where bias variables are not input in the generation of one of the sets of output data. Accordingly, if there is a meaningful difference between these outputs, it can be analyzed to obtain an automatic estimation of bias, for example, as an output logit that can be normalized for comparison. The analysis can include determining an estimated bias output value based at least on a fit of a linear model between the first data set and the second data set; then determining a materiality output value based at least on a likelihood ratio test conducted against the estimated bias output value. The two values can be used together (or in some cases, separately) for bias estimation as a useful, computer generated proxy value, and the values can be recorded on a coupled data storage, for example, as time-stamped metadata associated with the particular version of the target trained machine learning model.

Accordingly, over a period of time, the data storage can generate estimated bias and trend data through recorded metadata associated with each trained machine learning model. As the generation of estimated bias data can be computationally burdensome, as noted, the process may be configured to operate as a night time batch process in an effort to utilize computing time while computing resources may be more available.

The model pipeline control data process is run by a model pipeline control data process controller 710, which can be a continuously running data process that creates, manages, and runs machine learning models (similar to a supervisor or hypervisor process). The model pipeline control data process can be configured to take as an input the recorded metadata, or in some embodiments, is configured to proactively interrogate the recorded metadata to make a determination that the estimated bias output value and the materiality output value associated with the target trained machine learning model are both greater than a threshold data value, in which case, it can be configured for automatically taking certain remedial actions as it relates to the models under its supervision.

The model pipeline control data process controller 710, in some embodiments, can generate and transmit an instruction signal to a model pipeline control data process to cease usage of the target trained machine learning model. This can be conducted, for example, by changing the API configuration and interface connections of the target trained machine learning model, removing it from production usage. The API configuration and interface connections of the target trained machine learning model can then be shifted into a test environment for downstream investigation as to why an ethical bias is estimated to have been incorporated (it is also possible that the ethical bias determination is spurious). For example, if a particular model appears to start to become biased against a particular gender through the machine's automatic assessment, out of an abundance of caution, the model pipeline control data process controller 710 can pre-emptively deactivate the model for investigation. Coupled with a periodically operated model pipeline control data process, a benefit of this approach is that latent spaces of coupled machine learning models can be responsibly monitored on a nightly basis, for example, which is a helpful process and useful in situations where models are being constantly trained using new input data sets (e.g., where real-time feedback is being incorporated), and there is a risk of an inadvertent bias being inadvertently added during the training process. This is also useful in situations where the new input data sets may be being provided from suspect or incomplete data sources, which may also inadvertently introduce ethical biases, potentially disadvantaging a protected group without intentionality from the data scientists.

In another embodiment, the model pipeline control data process controller 710 can be configured to instead of deactivating a particular target trained machine learning model, is configured to “roll back” the target trained machine learning model to a previous model version where the metadata indicates that no material ethical bias was found for a particular bias variable. If prior versions or snapshots of the models are maintained in storage, a trained model can be unloaded and replaced with the earlier trained version (e.g., older version of parameters stored as a data structure are loaded on an initiated but untrained mode), and the model pipeline control data process controller 710 can begin production usage of the recent past instance of the target trained machine learning model by connecting it to the API connectors 714 that were being used previously by the target trained machine learning model. Accordingly, as part of the “rollback”, from an external user perspective, the changeover may appear seamless. In some cases, multiple variants of a same trained machine learning model can be maintained simultaneously to provide a “hot swapping” capability to an earlier model.

Similarly, in another variant, the model pipeline control data process controller 710 can be controlled to instead identify an alternate trained machine learning model and begin usage of the alternate trained machine learning model. This is useful in situations where there are no snapshots available, or potentially the ethical bias is arising due to the specific architecture of a particular model, and using an alternate, differently architected model is required. Similarly, as an example implementation, the exposed API interfaces can simply be controlled to be rerouted or remapped to the alternate trained machine learning model.

In yet another variant, instead of using an alternate or earlier version of the trained machine learning model, the approach can include instead causing the re-training of a model using a different input set, a different architecture, or, in some embodiments, different starting conditions or hyperparameters. The trained machine learning model may be reverted to an untrained state (or simply a un-trained model can be instantiated for re-training. The re-training process can include using different data sources, different data sets, among others. In some embodiments, the trained machine learning model can be re-evaluated prior to deployment through API coupling or re-mapping.

In yet another variant, the model pipeline control data process controller 710 is configured instead to run a second level of testing before taking automatic action, and this can include using different mirrored variants of the bias and control variables in an effort to identify further whether the estimation of ethical bias is due to a variable under the influence of the institution (e.g., a credit limit amount), or a variable that is not under the influence of the institution. This can include using bureau variables as the control variables, and generating an updated estimated bias output value and updated materiality output value.

If there is a second determination that the updated estimated bias output value and the updated materiality output value associated with the target trained machine learning model are below the threshold data value, the model can continue to operate but can be associated with a flag data structure. The flag can be used by downstream operators to identify potentially problematic models for deeper investigation.

To support the triggered operations due to outputs from the ethical bias observer mechanism, the model pipeline control data process controller 710 can be configured to maintain backup and older instances of various trained machine learning models, which can be an important consideration when models are being used in an “online training” type model where they are being constantly trained with new real-world data. This can also include reinforcement training based models. In some embodiments, the model pipeline control data process controller 710 is configured to distinguish between different types of models and their training frequency, and apply a differing analysis schedule proportionate to their training frequency. For example, if a static model is being applied with little to no training, a periodic process does not need to operate constantly to check it for potential ethical bias. On the other hand, a model receiving real-time updates for continuous training may be scheduled with a high frequency of analyses to account for bias drifts and trends. In some embodiments, the metadata also includes a time-weighted variant or aggregated variant, which can be used instead of the raw scores for bias tracking. This allows for the system to be less prone to jitter, for example, alternatively classifying a particular model as problematic and non-problematic over different review epochs.

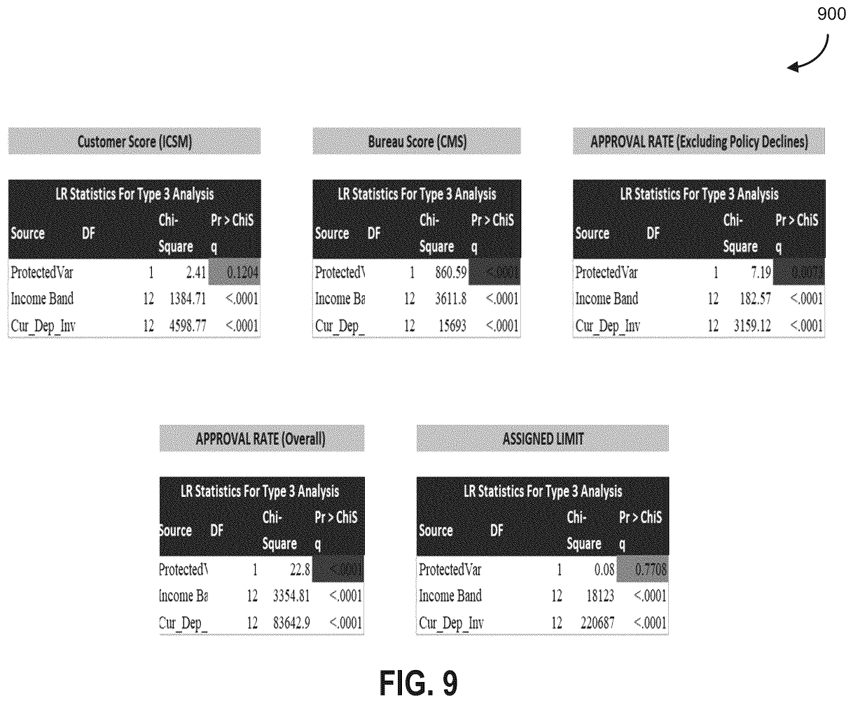

FIG. 9 shows example scores and statistical analysis 900, according to some embodiments.

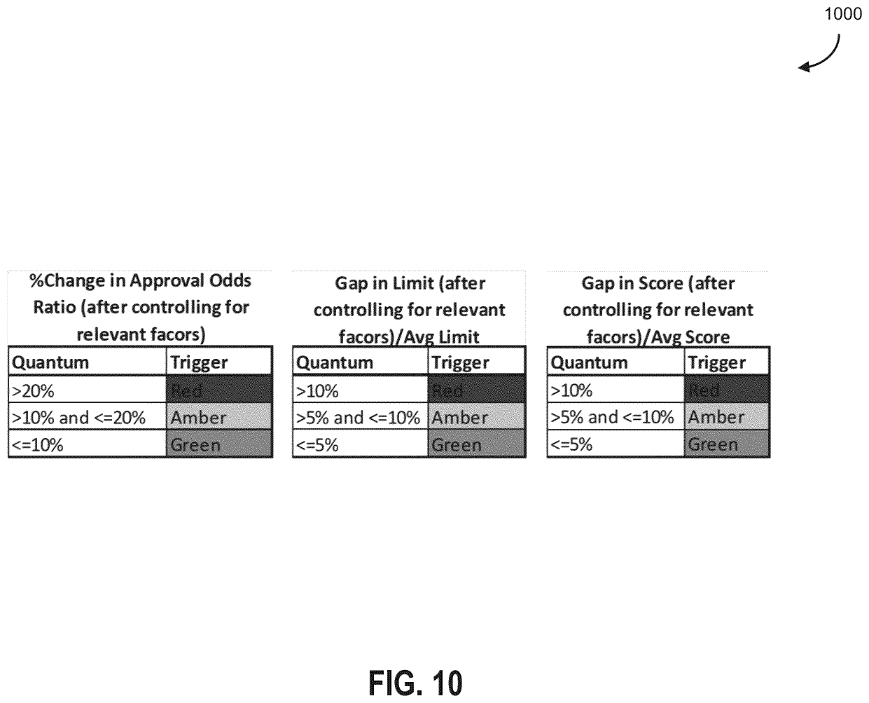

FIG. 10 is a set of tables 1000 showing example red amber green triggers at different quanta.

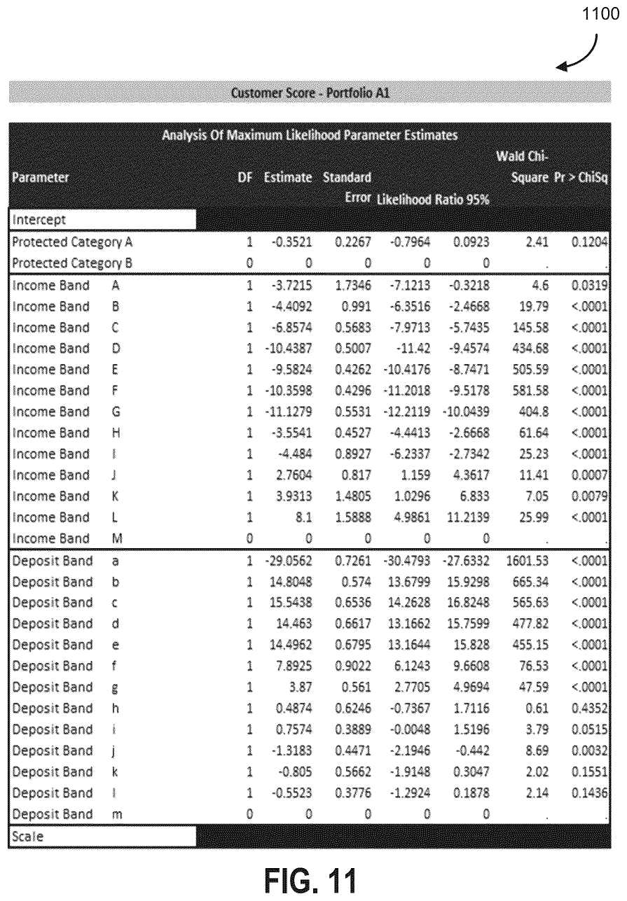

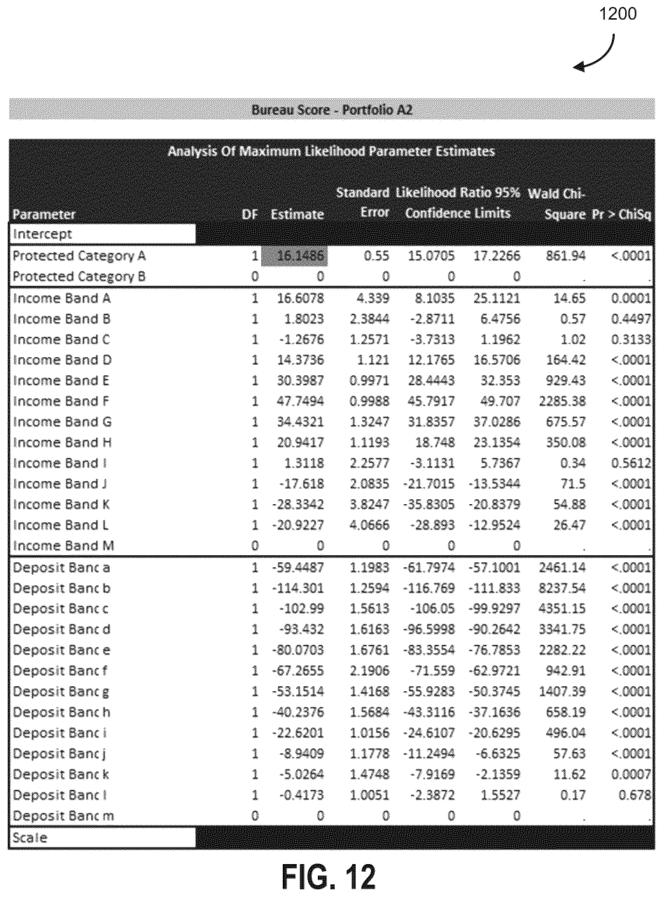

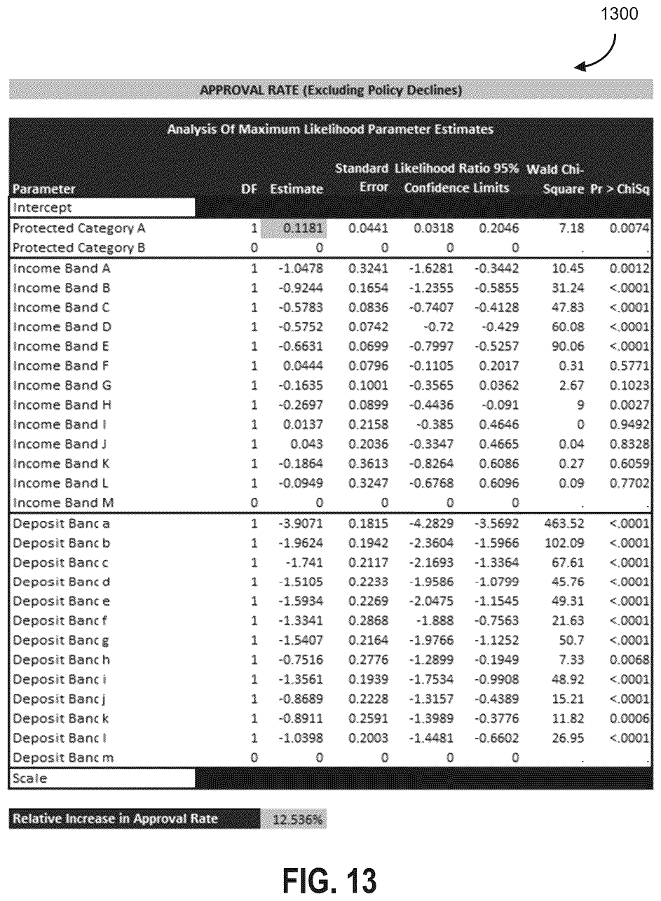

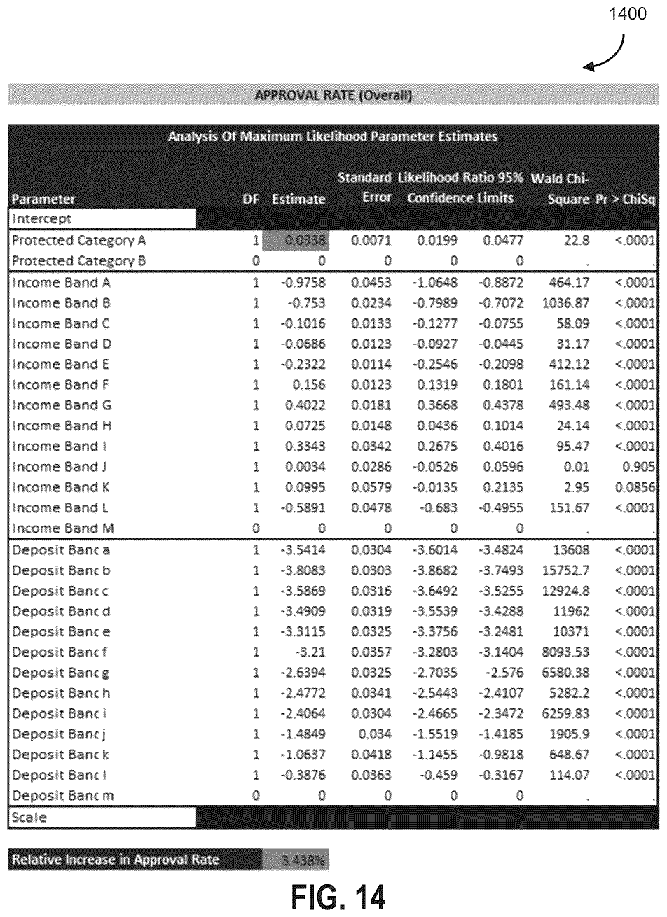

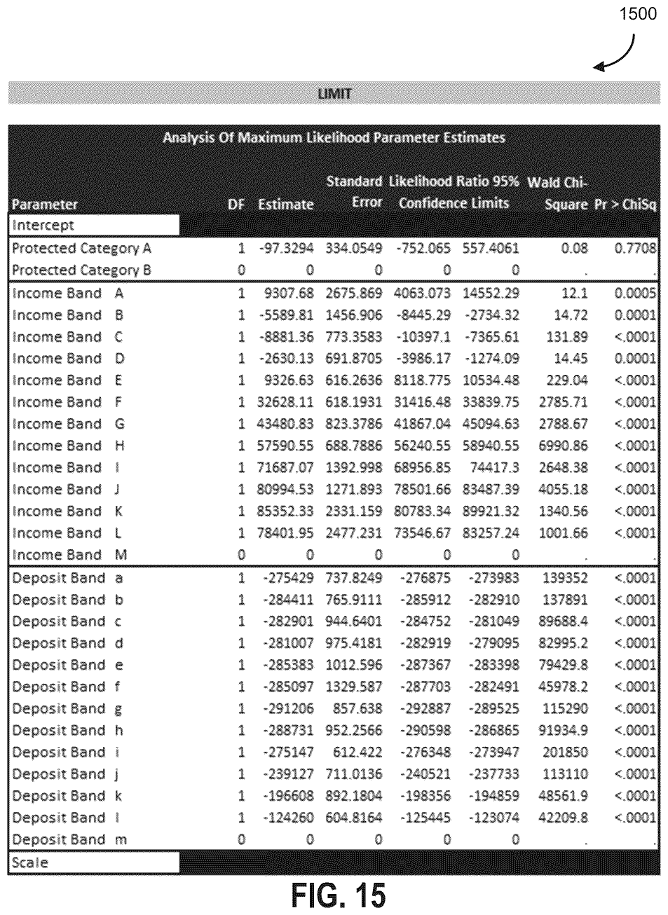

FIGS. 11, 12, 13, 14, 15 are charts 1100, 1200, 1300, 1400, 1500, showing example statistical analyses for an example protected variable.

In this example, as shown in FIG. 9, three of these example model cases show evidence of bias and two do not show bias. The three cases which show evidence of bias are checked for materiality. FIGS. 11, 12, 13, 14, 15 are provided to show example materiality bias analysis. For example, a coefficient of 16.1486 score points for the protected variable after controlling for Income and wealth translates to a 0.5% relative increase in bureau scores for protected variable compared to protected variable after adjusting for control factors. As this is below 5%, it leads to a green trigger. A coefficient of 0.1181 for protected variable after controlling for income and wealth translates to a 12.54% relative increase in approval rates for protected variable compared to protected variable after adjusting for control factors. As this is in the 10%-20% range, it leads to an amber trigger. A coefficient of 0.0338 for protected variable after controlling for income and wealth translates to a 3.44% relative increase in approval rates for protected variable compared to protected variable after adjusting for control factors. As this is below 10%, it leads to a green trigger. The type of trigger (red, amber, green) is provided as an illustrative example for the reader. In practical implementation, the classification of red, amber, green, can be used as an automatic trigger for different types of remedial data processes being invoked, as described in various embodiments herein. Amber triggers can flag a version of a trained model for observation during further training, while red triggers can automatically cause a revocation and/or rollback or replacement with a backup/alternate trained model through swapping API credentials, for example, moving a model from a production environment to an unexposed test environment operation for investigation.

It is important to note that the examples provided in this disclosure are dummy examples as the focus of this document is describe technical aspects of the solution. Certain information has been redacted or modified due to sensitivity of the underlying analysis.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

Example Visualization and SAS code

```
/*a) Income Distribution*/
proc freq data=e;
tables “Income Band”N / out=Freq2Out;
run;
proc sgplot data=Freq2Out;
vbar “Income Band”N /response=Percent;
run;
/*b) Wealth (Deposit+Investment)*/
proc freq data=e;
tables CUR_DEP_INV / out=Freq2Out;
run;
proc sgplot data=Freq2Out;
vbar CUR_DEP_INV /response=Percent;
run;
/*c) BOXPLOT OF Customer Score ACROSS GENDER*/
proc sgplot data=e;
vbox N_CUST_BEH_SCR/ category=GNDR_CDE;
run;
/*d) BOXPLOT OF Customer Scor) ACROSS APPROVAL STATUS*/
proc sgplot data=e;
vbox N_CUST_BEH_SCR/ category=FINAL_APPLICATION_STATUS;
run;
/*e) BOXPLOT OF CMS (Bureau Score) ACROSS GENDER*/
proc sgplot data=e;
vbox N_CB_CMS_SCR/ category=GNDR_CDE;
run;
/*f) BOXPLOT OF CMS (Bureau Score) ACROSS APPROVAL STATUS*/
proc sgplot data=e;
vbox N_CB_CMS_SCR/ category=FINAL_APPLICATION_STATUS;
run;
/*BAR CHART OF APPROVE/DECLINE BY GENDER*/
proc freq data=e;
tables FINAL_APPLICATION_STATUS*GNDR_CDE / out=Freq2Out;
run;
proc means data=Freq2Out;
var count;
class gndr_cde;
output out=Freq2OutSum(where=(_type_=1)) sum=TOT;
run;
proc sort data=Freq2Out; by gndr_cde; run;
data Freq2Out;
  merge Freq2Out(in=a) Freq2OutSum(in=b keep=gndr_cde TOT);
  by gndr_cde;
  if a and b;
  Percent = Count/Tot;
  format Percent PERCENT5.;
  Label Percent=“Accept/Decline Rate”;
run;
/*g) BAR CHART OF APPROVE/DECLINE BY GENDER - EXCLUDING POLICY
DECLINES */
proc freq data=e;
tables FINAL_APPLICATION_STATUS*GNDR_CDE / out=Freq2Out;
run;
proc means data=Freq2Out;
var count;
class gndr_cde;
output out=Freq2OutSum(where=(_type_=1)) sum=TOT;
run;
proc sort data=Freq2Out; by gndr_cde; run;
data Freq2Out;
  merge Freq2Out(in=a) Freq2OutSum(in=b keep=gndr_cde TOT);
  by gndr_cde;
  if a and b;
  Percent = Count/Tot;
  format Percent PERCENT5.;
  Label Percent=“Accept/Decline Rate”;
run;
proc sgplot data=Freq2Out;
vbar GNDR_CDE /group=FINAL_APPLICATION_STATUS groupdisplay=stacked
response=Percent;
run;
/*h) BAR CHART OF APPROVE/DECLINE BY GENDER - INCLUDING POLICY
DECLINES*/
proc freq data=e;
tables FINAL_APPLICATION_STATUS*GNDR_CDE / out=Freq2Out;
run;
proc means data=Freq2Out;
var count;
class gndr_cde;
output out=Freq2OutSum(where=(_type_=1)) sum=TOT;
run;
proc sort data=Freq2Out; by gndr_cde; run;
data Freq2Out;
  merge Freq2Out(in=a) Freq2OutSum(in=b keep=gndr_cde TOT);
  by gndr_cde;
  if a and b;
  Percent = Count/Tot;
  format Percent PERCENT5.;
  Label Percent=“Accept/Decline Rate”;
run;
proc sgplot data=Freq2Out;
vbar GNDR_CDE /group=FINAL_APPLICATION_STATUS groupdisplay=stacked
response=Percent;
run;
/*i) HISTOGRAM OF LIMIT FOR APPROVED APPLICANTS*/
proc sgplot data=e;
vbox A_FINAL_DEC_CR_LMT_AMT/ category=gndr_cde;
run;
/*TEST BIAS IN CUSTOMER SCORE*/
proc genmod data=e;
class GNDR_CDE “Income Band”N CUR_DEP_INV;
model N_CUST_BEH_SCR=GNDR_CDE “Income Band”N CUR_DEP_INV/DIST=normal
LINK=identity LRCI TYPE3;
run;
/*TEST BIAS IN BUREAU SCORE*/
proc genmod data=e;
class GNDR_CDE “Income Band”N CUR_DEP_INV;
model N_CB_CMS_SCR=GNDR_CDE “Income Band”N CUR_DEP_INV/DIST=normal
LINK=identity LRCI TYPE3;
run;
/*TEST BIAS IN APPROVAL RATE - EXCLUDING POLICY DECLINES*/
proc genmod data=e;
  class GNDR_CDE “Income Band”N CAR_OWN_CDE AUTO_RPMT_IND
CUR_DEP_INV;
  model FINAL_APPLICATION_STATUS = GNDR_CDE “Income Band”N
CUR_DEP_INV / dist = bin
    link = logit
    lrci TYPE3;
run;
/*TEST BIAS IN APPROVAL RATE - INCLUDING POLICY DECLINES*/
proc genmod data=e;
  class GNDR_CDE “Income Band”N CAR_OWN_CDE AUTO_RPMT_IND
CUR_DEP_INV;
  model FINAL_APPLICATION_STATUS = GNDR_CDE “Income Band”N
CUR_DEP_INV / dist = bin
    link = logit
    lrci TYPE3;
run;
/*TEST BIAS IN ASSIGNED LIMIT IN THE SCORED BASE*/
proc genmod data=e;
  class GNDR_CDE “Income Band”N CAR_OWN_CDE AUTO_RPMT_IND
CUR_DEP_INV;
  model A_FINAL_DEC_CR_LMT_AMT = GNDR_CDE “Income Band”N CUR_DEP_INV
/ dist = NORMAL
    link = IDENTITY
    lrci TYPE3;
run;
```

What is claimed:

1. A computer implemented system for computationally analyzing a target trained machine learning model to generate at least one estimation value representative of a potential ethical bias present in the target trained machine learning model, the system comprising:
a computer processor operating in conjunction with non-transitory computer readable memory, the computer processor configured to:
identify a bias variable for testing the target trained machine learning model;
generate a first data set, the first data set comprising a set of control variables and bias variables for input to the target trained machine learning model;
generate a second data set, the second data set comprising the set of control variables, and not the bias variables, for input to the trained target machine learning model;
process, the first data set and the second data set using the trained target machine learning model to generate a corresponding first set of output data and a second set of output data;
determine an estimated bias output value based at least on a fit of a linear model between the first output data and the second output data;
determine a materiality output value based at least on a likelihood ratio test conducted against the estimated bias output value;
and
record at least one of the estimated bias output value and the materiality output value in a data storage as metadata associated with the target trained machine learning model.

2. The computer implemented system of claim 1, wherein the computer processor is further configured to:
upon a determination that the estimated bias output value and the materiality output value associated with the target trained machine learning model are both greater than a threshold data value, generate and transmit an instruction signal to a model pipeline control data process to cease usage of the target trained machine learning model.

3. The computer implemented system of claim 2, wherein the computer processor is further configured to:
identify a recent past instance of the target trained machine learning model; and
generate and transmit an instruction signal to the model pipeline control data process to begin usage of the recent past instance of the target trained machine learning model.

4. The computer implemented system of claim 2, wherein the computer processor is further configured to:
identify an alternate trained machine learning model; and
generate and transmit an instruction signal to the model pipeline control data process to begin usage of the alternate trained machine learning model.

5. The computer implemented system of claim 2, wherein the computer processor is further configured to:
generate and transmit an instruction signal to the model pipeline control data process to initiate retraining of the target trained machine learning model;
determine an updated estimated bias output value based at least on the fit of the linear model between outputs of the first data set and the second data set run on a re-trained target trained machine learning model;
determine an updated materiality output value based at least on a likelihood ratio test conducted against the estimated bias output value; and
upon a determination that the updated estimated bias output value and updated materiality output value being below the threshold data value; and
generate and transmit an instruction signal to the model pipeline control data process to reinstate the re-trained target trained machine learning model.

6. The computer implemented system of claim 2, wherein the computer processor is further configured to:
upon a determination that the estimated bias output value and the materiality output value associated with the target trained machine learning model are both greater than a threshold data value, re-run a bias test using bureau variables as the control variables, and generating an updated estimated bias output value and updated materiality output value; and
upon a second determination that the updated estimated bias output value and the updated materiality output value associated with the target trained machine learning model are below the threshold data value; associate a flag data structure with the target trained machine learning model during continued operation of the target trained machine learning model.

7. The computer implemented system of claim 1, wherein the computer processor is further configured to:
periodically determine and record time-stamped versions of the estimated bias output value and the materiality output value for the trained machine learning model; and
generate one or more backup snapshot instances of the trained machine learning, triggered by the estimated bias output value and the materiality output value being below a threshold data value; wherein the trained machine learning model is a reinforcement learning model.

8. The computer implemented system of claim 1, wherein the computer processor is further configured to:
periodically determine and record time-stamped versions of the estimated bias output value and the materiality output value for the trained machine learning model; and
generate one or more backup snapshot instances of the trained machine learning, triggered by the estimated bias output value and the materiality output value being below a threshold data value; wherein the trained machine learning model is a machine learning model being trained using new real-time data.

9. The computer implemented system of claim 2, wherein the model pipeline control data process is configured to selectively control an exposed application programming interface (API).

10. The computer implemented system of claim 9, wherein the model pipeline control data process ceases operation of the trained machine learning model by disconnecting the trained machine learning model from the exposed application programming interface (API).

11. A computer implemented method for computationally analyzing a target trained machine learning model to generate at least one estimation value representative of a potential ethical bias present in the target trained machine learning model, the method comprising:
identifying a bias variable for testing the target trained machine learning model;
generate a first data set, the first data set comprising a set of control variables and bias variables for input to the target trained machine learning model;
generate a second data set, the second data set comprising the set of control variables, and not the bias variables, for input to the trained target machine learning model;
processing, the first data set and the second data set using the trained target machine learning model to generate a corresponding first set of output data and a second set of output data;
determining an estimated bias output value based at least on a fit of a linear model between the first output data and the second output data;
determining a materiality output value based at least on a likelihood ratio test conducted against the estimated bias output value;
and
recording at least one of the estimated bias output value and the materiality output value in a data storage as metadata associated with the target trained machine learning model.

12. The computer implemented method of claim 11, further comprising upon a determination that the estimated bias output value and the materiality output value associated with the target trained machine learning model are both greater than a threshold data value, generating and transmitting an instruction signal to a model pipeline control data process to cease usage of the target trained machine learning model.

13. The computer implemented method of claim 12, further comprising:
identifying a recent past instance of the target trained machine learning model; and
generating and transmitting an instruction signal to the model pipeline control data process to begin usage of the recent past instance of the target trained machine learning model.

14. The computer implemented method of claim 12, further comprising:
identify an alternate trained machine learning model; and
generate and transmit an instruction signal to the model pipeline control data process to begin usage of the alternate trained machine learning model.

15. The computer implemented system of claim 12, further comprising:
generating and transmitting an instruction signal to the model pipeline control data process to initiate retraining of the target trained machine learning model;
determining an updated estimated bias output value based at least on the fit of the linear model between outputs of the first data set and the second data set run on a re-trained target trained machine learning model;
determining an updated materiality output value based at least on a likelihood ratio test conducted against the estimated bias output value; and
upon a determination that the updated estimated bias output value and updated materiality output value being below the threshold data value; and
generating and transmitting an instruction signal to the model pipeline control data process to reinstate the re-trained target trained machine learning model.

16. The computer implemented method of claim 12, further comprising: upon a determination that the estimated bias output value and the materiality output value associated with the target trained machine learning model are both greater than a threshold data value, re-running a bias test using bureau variables as the control variables, and generating an updated estimated bias output value and updated materiality output value; and
upon a second determination that the updated estimated bias output value and the updated materiality output value associated with the target trained machine learning model are below the threshold data value; associating a flag data structure with the target trained machine learning model during continued operation of the target trained machine learning model.

17. The computer implemented method of claim 11, further comprising: periodically determining and recording time-stamped versions of the estimated bias output value and the materiality output value for the trained machine learning model; and
generate one or more backup snapshot instances of the trained machine learning, triggered by the estimated bias output value and the materiality output value being below a threshold data value; wherein the trained machine learning model is a reinforcement learning model.

18. The computer implemented method of claim 11, further comprising:
periodically determining and recording time-stamped versions of the estimated bias output value and the materiality output value for the trained machine learning model;
and
generating one or more backup snapshot instances of the trained machine learning, triggered by the estimated bias output value and the materiality output value being below a threshold data value; wherein the trained machine learning model is a machine learning model being trained using new real-time data.

19. The computer implemented method of claim 12, wherein the model pipeline control data process is configured to selectively control an exposed application programming interface (API).

20. A non-transitory computer readable medium, storing machine interpretable instructions, which when executed by a processor, cause the processor to perform a computer implemented method for computationally analyzing a target trained machine learning model to generate at least one estimation value representative of a potential ethical bias present in the target trained machine learning model, the method comprising:
identifying a bias variable for testing the target trained machine learning model;
generate a first data set, the first data set comprising a set of control variables and bias variables for input to the target trained machine learning model;
generate a second data set, the second data set comprising the set of control variables, and not the bias variables, for input to the trained target machine learning model;
processing, the first data set and the second data set using the trained target machine learning model to generate a corresponding first set of output data and a second set of output data;
determining an estimated bias output value based at least on a fit of a linear model between the first output data and the second output data;
determining a materiality output value based at least on a likelihood ratio test conducted against the estimated bias output value;
and
recording at least one of the estimated bias output value and the materiality output value in a data storage as metadata associated with the target trained machine learning model.
